(19) United States
(12) Patent Application Publication
(10) Pub. No.: US 2025/0060730 A1
(43) Pub. Date: Feb. 20, 2025

(54) SWARM ROBOT COLLABORATION FOR LIGHT BEAM MODULATION

(71) Applicant: International Business Machines Corporation, Armonk, NY (US)

(72) Inventors: Manikandan Padmanaban, Chennai (IN); Jagabondhu Hazra, Bangalore (IN); Sarbajit K. Rakshit, Kolkata (IN)

(21) Appl. No.: 18/449,129

(22) Filed: Aug. 14, 2023

(51) Int. Cl. G05B 19/4155; B29C 64/124; B29C 64/268; B29C 64/393; B33Y 10/00; B33Y 30/00; B33Y 50/02; G05D 1/00

(52) U.S. Cl. CPC G05B 19/4155; B29C 64/124; B29C 64/268; B29C 64/393; B33Y 10/00; B33Y 30/00; B33Y 50/02; G05B 2219/39146

(57) ABSTRACT

One or more systems, methods, and/or computer program products of use provided herein relate to swarm robot collaboration for light beam modulation. A system can comprise a photosensitive resin tank. The system can further comprise a plurality of swarm robots moving inside the photosensitive resin tank, where respective swarm robots can occupy positions relative to one another to modulate respective direction of light beams emitted by a subset of the plurality of swarm robots.

### BACKGROUND

The subject disclosure relates to robots, and, more specifically, to swarm robot collaboration for light beam modulation.

### SUMMARY

The following presents a summary to provide a basic understanding of one or more embodiments described herein. This summary is not intended to identify key or critical elements, delineate scope of particular embodiments or scope of claims. Its sole purpose is to present concepts in a simplified form as a prelude to the more detailed description that is presented later. In one or more embodiments described herein, systems, methods, apparatus and/or computer program products that can facilitate swarm robot collaboration for modulation of light beams to manufacture a three-dimensional (3D) object are discussed.

According to an embodiment, a system is provided. The system can comprise a photosensitive resin tank. The system can further comprise a plurality of swarm robots moving inside the photosensitive resin tank, where respective swarm robots can occupy positions relative to one another to modulate respective direction of light beams emitted by a subset of the plurality of swarm robots.

According to another embodiment, a computer program product for collaboration of swarm robots for light beam modulation is provided. The computer program product can comprise a computer readable storage medium having program instructions embodied therewith, the program instructions executable by a processor of a swarm robot to cause the processor to communicate with respective swarm robots of a first set of swarm robots and a second set of swarm robots to cause the respective swarm robots to occupy positions relative to one another inside a photosensitive resin tank to modulate respective direction of light beams emitted by the first set of swarm robots.

According to yet another embodiment, a method is provided. The method can comprise occupying, by respective swarm robots of a plurality of swarm robots, positions relative to one another inside a photosensitive resin tank. The method can further comprise modulating, by the respective swarm robots, respective direction of light beams emitted by a subset of the plurality of swarm robots.

### BRIEF DESCRIPTION OF THE DRAWINGS

FIG. 1 illustrates a system diagram of an example, non-limiting system that can facilitate swarm robot collaboration for production of a 3D object from photosensitive resin in accordance with one or more embodiments described herein.

FIG. 2 illustrates an example, non-limiting 3D object that can be manufactured from photosensitive resin in accordance with one or more embodiments described herein.

FIG. 3 illustrates a system diagram of an example, non-limiting system that can facilitate light emission and modulation by swarm robots for production of a 3D object from photosensitive resin in accordance with one or more embodiments described herein.

FIG. 4 illustrates ray diagrams of example, non-limiting concepts that can be implemented by swarm robots for production of a 3D object from photosensitive resin in accordance with one or more embodiments described herein.

FIG. 5 illustrates a diagram of example, non-limiting functionalities that can be provided by a surface associated with a swarm robot for production of a 3D object from photosensitive resin in accordance with one or more embodiments described herein.

FIG. 6 illustrates a diagram of an example, non-limiting absorption functionality that can be provided by a swarm robot for production of a 3D object from photosensitive resin in accordance with one or more embodiments described herein.

FIG. 7 illustrates a flow diagram of an example, non-limiting method that can facilitate swarm robot collaboration for production of a 3D object from photosensitive resin in accordance with one or more embodiments described herein.

FIG. 8 illustrates another flow diagram of an example, non-limiting method that can facilitate swarm robot collaboration for production of a 3D object from photosensitive resin in accordance with one or more embodiments described herein.

FIG. 9 illustrates yet another flow diagram of an example, non-limiting method that can facilitate swarm robot collaboration for production of a 3D object from photosensitive resin in accordance with one or more embodiments described herein.

FIG. 10 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

When light falls on photosensitive resin, it solidifies the resin within a very short amount of time. Per recent developments, when a light-based holographic object is projected inside a photosensitive gel, a 3D object in the shape of the holographic object is created. Based on a profile of the light beam, the photosensitive resin is solidified in the shape of the 3D object to be manufactured. While manufacturing large 3D objects with photosensitive resin, controlling projection of light beams on the photosensitive resin can be one of the most challenging tasks because if a light beam goes beyond a target point, there can be a quality issue on the manufactured object. Further, projecting light only from the outside is not useful to precisely manufacture the object. Thus, a method and system for effectively manufacturing objects from photosensitive resin by controlling light beam modulation inside a photosensitive resin tank can be desirable.

Various embodiments of the present disclosure can be implemented to solve one or more of the problems discussed above. Embodiments described herein can include systems, methods, apparatus and/or computer program products that can facilitate swarm robot collaboration for light beam modulation to produce 3D objects. A swarm robot can be a robot that can exhibit swarm behavior by interacting with additional robots. In other words, in a swarm robotic system, multiple individual robots can coordinate as a system to exhibit swarm behavior. In an embodiment, a set of swarm robots can walk on a photosensitive resin tank comprising photosensitive resin to occupy appropriate relative positions from each other to modulate direction of light beams emitted from a subset of the swarm robots, wherein modulation of the direction of light beams can cause light to be projected on the photosensitive resin such that the photosensitive resin can solidify (via light based projection) in the shape of a 3D object to be manufactured. While modulating the direction of light beams inside the photosensitive resin tank, respective swarm robots can perform functions such as emitting a light beam, reflecting a light beam, deflecting the light beam, absorbing the light beam, converging, diverting, or splitting the light beam, etc.

Based on a shape and dimensions of the 3D object to be manufactured from the photosensitive resin, the respective swarm robots can identify whether the 3D object can be manufactured in one portion or in multiple split portions, followed by merging or assembling of the split portions post manufacturing. The determination of whether the 3D object can be manufactured at once or in multiple split portions can be based on simulation of light beam modulation with various combinations of light beam modulation methods inside the photosensitive resin. Further, based on the shape and the dimensions of the 3D object, the respective swarm robots can occupy appropriate relative positions inside the photosensitive resin tank and perform respective functions listed above to cause the respective swarm robots to create a precise light beam simulated model inside the photosensitive resin tank and manufacture the 3D object.

While performing mobility inside the photosensitive resin tank to occupy the appropriate relative positions, the respective swarm robots can cause turbulence within the photosensitive resin. The robotic system can wait for the turbulence to stop, and after validating that the turbulence has stopped, a subset of the swarm robots can begin emission of light while another subset of the swarm robots can begin modulation of the light emitted. Accordingly, the photosensitive resin exposed to the light can become solidified. As stated earlier, a swarm robot can be a robot that can exhibit swarm behavior by interacting with additional swarm robots. As such, respective swarm robots can comprise respective modules for reflecting a light beam, deflecting the light beam, absorbing the light beam, splitting the light beam, merging the light beam or other manipulation of the light beam to redirect the light beam, stop the light beam from propagating beyond a point, split the light beam on the photosensitive resin, etc. As such, the robotic system described herein can arrange the respective modules at appropriate angular positions to create a desired shape of a light-based sculpture (i.e., the 3D object to be manufactured). Based on a need for reflecting the light beam, deflecting the light beam, splitting the light beam, merging the light beam, etc., respective swarm robots can change a reflection or deflection surface profile, position of a splitting module, position of a merging module, etc. such that the light beam can be redirected in appropriate directions according to a shape and dimensions of the 3D object.

Various embodiments discussed herein can provide improvements in terms of precise manufacturing of 3D objects. For example, movement of the swarm robots inside the photosensitive resin tank can cause turbulence, and the swarm robots can validate that the turbulence has stopped before beginning the manufacturing process so that distortion of the 3D object can be avoided. Further, the swarm robots can modulate light to precisely identify how the 3D object can be created from the photosensitive resin by deflection of light, reflection of light, absorption of light or redirection of light. Various embodiments discussed herein can be used for manufacture of 3D objects, machine parts, toys, prototyping structures, etc. Additional aspects of the one or more embodiments discussed above are described in greater detail with reference to the figures.

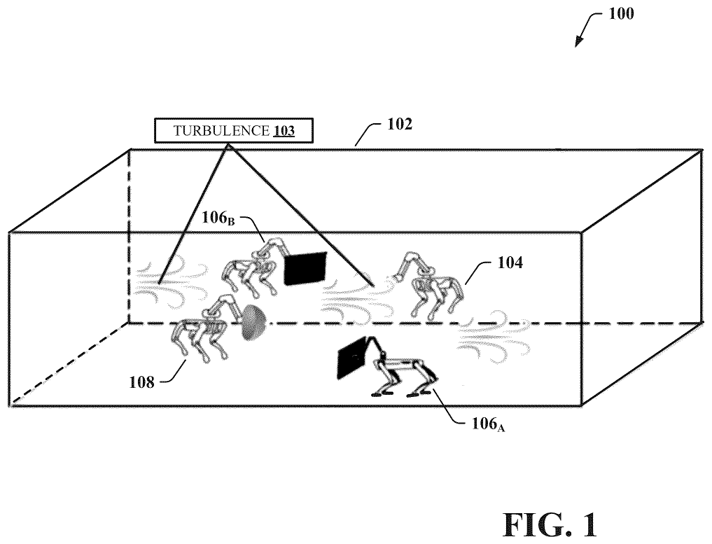

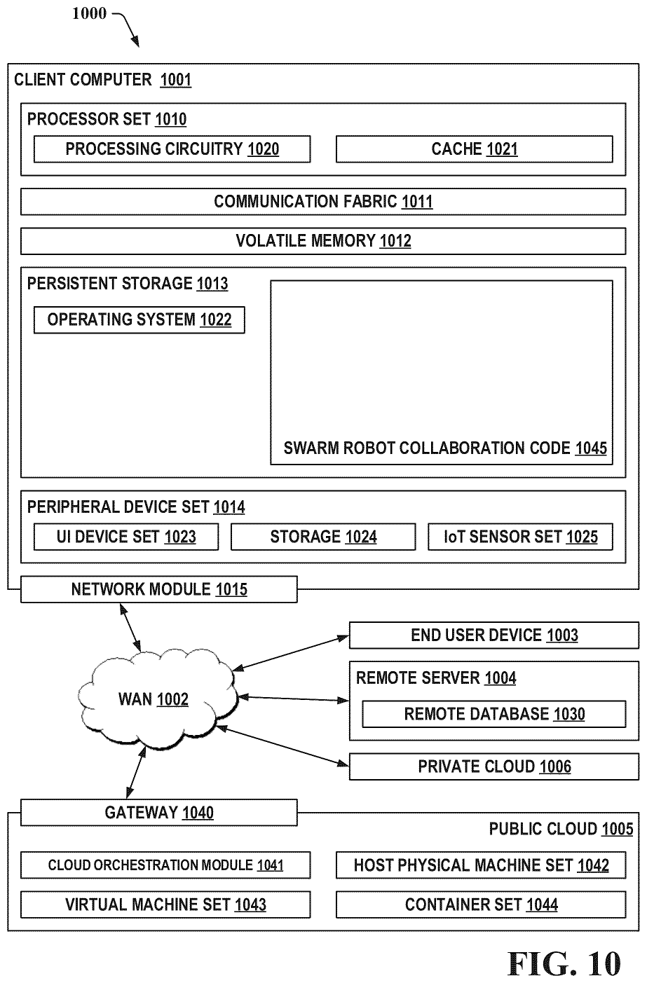

The embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting system 100 as illustrated at FIG. 1, and/or systems thereof, can further comprise, be associated with and/or be coupled to one or more computer and/or computing-based elements described herein with reference to an operating environment, such as the operating environment 1000 illustrated at FIG. 10. For example, system 100 can be associated with, such as accessible via, a computing environment 1000 described below with reference to FIG. 10, such that aspects of processing can be distributed between system 100 and the computing environment 1000. In one or more described embodiments, computer and/or computing-based elements can be used in connection with implementing one or more of the systems, devices, methods and/or computer-implemented operations shown and/or described in connection with FIG. 1 and/or with other figures described herein.

FIG. 1 illustrates a system diagram of an example, non-limiting system 100 that can facilitate swarm robot collaboration for production of a 3D object from photosensitive resin in accordance with one or more embodiments described herein.

The system 100 and/or the components of the system 100 can be employed to use hardware and/or software to solve problems that are highly technical in nature (e.g., related to robotic systems, manufacturing objects via light-based projection, etc.), that are not abstract and that cannot be performed as a set of mental acts by a human. Further, some of the processes performed may be performed by specialized computers for carrying out defined tasks related to the robotic systems, collaboration between swarm robots, etc. The system 100 can provide improvements in terms of precise manufacturing of 3D objects. For example, movement of the swarm robots inside the photosensitive resin tank can cause turbulence, and the swarm robots can validate that the turbulence has stopped before beginning a manufacturing process so that distortion of a 3D object can be avoided. Further, the swarm robots can modulate light to precisely identify how the 3D object can be created from the photosensitive resin by deflection of light, reflection of light, absorption of light or other redirection of light. Various embodiments discussed herein can be used to manufacture 3D objects, machine parts, toys, prototyping structures, etc.

System 100 can comprise photosensitive resin tank 102 and a plurality of swarm robots including robot 104, robot 106_{A}, robot 106_{B} and robot 108. It is to be appreciated that although only four robots are illustrated in the exemplary system diagram of FIG. 1, system 100 can comprise additional robots. Photosensitive resin tank 102 can comprise a chemical called photosensitive resin (a semi-solid type of gel) that can instantly solidify upon projection of light on the photosensitive resin, and the plurality of swarm robots can be immersed in the photosensitive resin inside photosensitive resin tank 102. In an embodiment, the plurality of swarm robots can move inside photosensitive resin tank 102, wherein respective swarm robots (e.g., robot 104, robot 106_{A}, robot 106_{B} and robot 108) can occupy positions relative to one another to modulate respective direction of light beams emitted by a subset of the plurality of swarm robots (e.g., robot 104). Modulation of the respective direction of light beams by the respective swarm robots can cause the photosensitive resin contained inside photosensitive resin tank 102 to solidify in a shape of a 3D object to be manufactured.

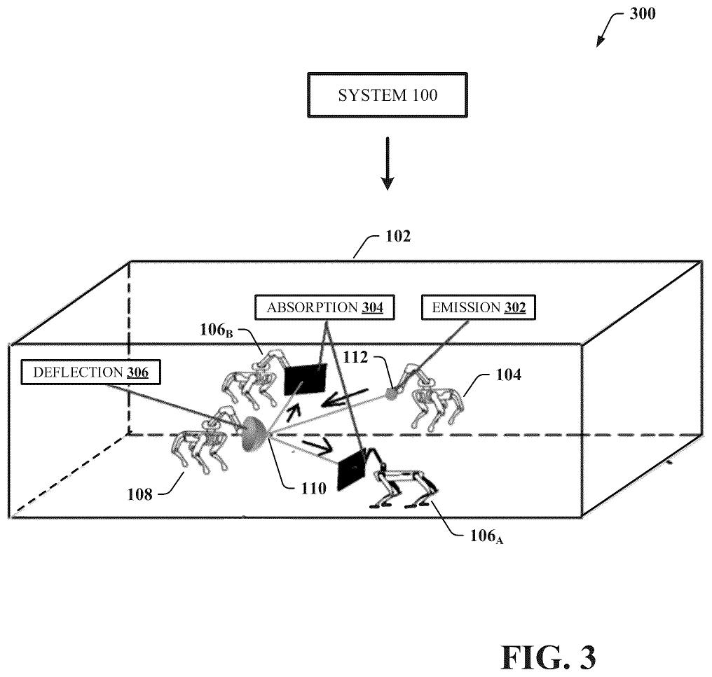

The respective swarm robots can analyze the 3D object to be manufactured to determine whether the 3D object can be produced in a single step or in multiple steps. The respective swarm robots can analyze the 3D object to be manufactured based on a data model of the 3D object. The data model can be a 3D model of the 3D object to be manufactured, wherein the data model can be analyzed by the respective swarm robots to identify a size of the 3D object to be manufactured. As such, a variety of 3D objects can be manufactured. The 3D model can be a scaled down model (e.g., versus a life-sized model) of the 3D object to be manufactured, and the respective swarm robots can receive the 3D model in a digital format based on which the respective swarm robots can identify positions that the respective swarm robots can occupy inside photosensitive resin tank 102 to manufacture the 3D object. That is, based on the shape and dimensions of the 3D object, the respective swarm robots can occupy positions relative to one another inside the photosensitive resin to create a light beam simulated model of the 3D object. For example, the respective robots can identify dimensions of photosensitive resin tank 102 and communicate with one another to identify relative positions and directions of the respective swarm robots inside photosensitive resin tank 102. For example, with reference to FIG. 3, based on a 3D model (digital model) received by the respective swarm robots, the respective swarm robots can identify that a distance between point 110 and point 112 is to be 20 centimeters (cm) at a particular angle, and whether the relative positions of robot 104 and robot 108 create the distance of 20 cm. In an embodiment, at least two split portions of the 3D object can be manufactured when constructing the 3D object in multiple steps, and the at least two split portions can be merged or assembled after manufacturing the at least two split portions to form the 3D object.

The respective swarm robots can be walking robots (e.g., like a Spot robot) that can walk inside photosensitive resin tank 102, and different swarm robots can perform respective individual functions. As such, the respective swarm robots can comprise respective modules for performing the respective individual functions for producing the 3D object, and system 100 can arrange the respective modules at angular positions suitable for producing the 3D object, for example, based on each swarm robot having six degrees of freedom. The respective individual functions can be selected from a group comprising at least one of emitting a light beam, reflecting the light beam, deflecting the light beam, absorbing the light beam, or converging, diverting, or splitting the light beam. For example, as described above, the respective swarm robots can identify positions to occupy relative to one another (e.g., as illustrated in FIG. 1) inside photosensitive resin tank 102, such that via light direction simulation, the respective swarm robots can identify whether the 3D object can be manufactured and how the 3D object can be manufactured. Thereafter, the respective swarm robots can walk on the tank to occupy the positions identified. Some of the respective swarm robots can emit light beams whereas other swarm robots can reflect (e.g., via a mirror), deflect or absorb the emitted light beams. For example, robot 104 can emit a light beam, robot 108 can deflect the light beam emitted by robot 104, and robots 106_{A} and 106_{B} can absorb the light beams deflected by robot 108. It is to be appreciated that more than one robot can perform a particular function. That is, although not illustrated in FIG. 1, photosensitive resin tank 102 can comprise additional swarm robots, such as robot 104, that can emit light. Likewise photosensitive resin tank 102 can comprise additional swarm robots, such as robot 108, that can deflect the emitted light, and additional swarm robots, such as robots 106_{A} and 106_{B}, that can absorb the reflected light. Each swarm robot can also self-adjust in height for manufacturing the 3D object. As stated elsewhere herein, the swarm robots can be walking robots so that they can get the required physical support, and the swarm robots can walk on the tank and perform different roles such as reflection of light, deflection of light, absorption of light, etc.

Motion performed by the respective swarm robots for occupying the positions inside photosensitive resin tank 102 can cause turbulence (e.g., turbulence 103) inside the photosensitive resin, and the respective swarm robots can begin production of the 3D object after validating that the turbulence has stopped. For example, once the respective swarm robots assume the respective positions, the respective swarm robots can validate whether the turbulence has stopped, simulate that the exact positions needed for manufacturing the 3D object have been assumed by the respective swarm robots and thereafter, begin emission and modulation of light to begin manufacturing the 3D object. A swarm robot can validate that turbulence has stopped via a vibration detection sensor, movement detection sensor, a camera or other such sensor installed internal to or external to the swarm robot, wherein the sensor can detect whether the photosensitive resin is in motion or at a standstill. The process of validating whether turbulence has stopped can be performed multiple times during manufacturing of a 3D object or a portion of the 3D object since the respective swarm robots can perform several movements, based on the size and dimension of the 3D object, to manufacture the 3D object. As such, starting the manufacturing process before ensuring that the turbulence has stopped can cause the 3D object to become distorted.

Thus, multiple robots (e.g., robot 104, robot 106_{A}, robot 106_{B} and robot 108) can create a swarm among themselves and work in a collaborative manner to produce the 3D object. The respective swarm robots can communicate with each other via radio communication, infrared communication or by connecting to a remote system and transmitting signals. Further, light emitted by robot 104 can be a light emitting diode (LED) light. Robot 104 (and/or one or more other light emitting robots) can each comprise a digital light processor (DLP)-based projector that can project light on a mirror (e.g., a light mirroring module coupled to robot 108) and/or an absorber (e.g., a light absorbing module coupled to robots 106_{A} and 106_{B}). Photosensitive resin tank 102 can comprise different types of photosensitive resins with different solidification capabilities.

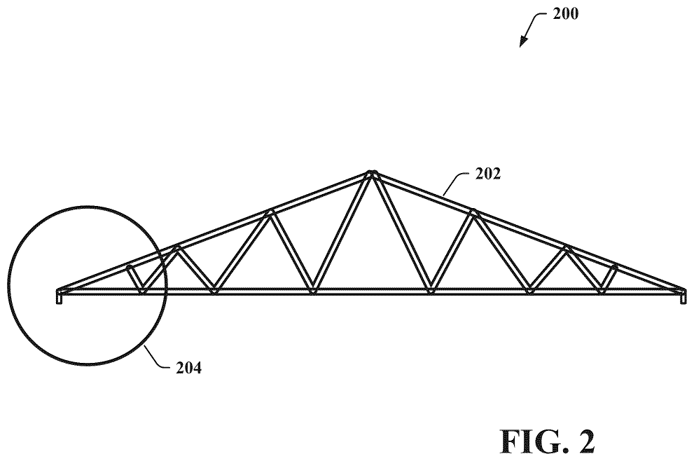

FIG. 2 illustrates an example, non-limiting 3D object 200 that can be manufactured from photosensitive resin in accordance with one or more embodiments described herein. Repetitive description of like elements and/or processes employed in respective embodiments is omitted for sake of brevity.

In an embodiment, a system (e.g., system 100, system 300) can comprise a photosensitive resin tank (e.g., photosensitive resin tank 102) comprising photosensitive resin, a first set of swarm robots (e.g., robot 104 and/or one or more additional light emitting robots) and a second set of swarm robots (e.g., robot 106_{A}, robot 1068, robot 108 and/or one or more additional light reflecting, light deflecting and/or light absorbing robots) immersed in the photosensitive resin. Respective swarm robots of the first set of swarm robots and the second set of swarm robots can occupy positions relative to one another inside the photosensitive resin tank to modulate respective direction of light beams emitted by the first set of swarm robots. The first set of swarm robots can comprise a light beam emission module for emitting the light beams, and the second set of swarm robots can comprise modules for reflecting the light beams, deflecting the light beams, and/or absorbing the light beams to modulate the respective direction of the light beams. Modulation of the respective direction of light beams by the respective swarm robots can cause the photosensitive resin contained inside the photosensitive resin tank to solidify in a shape of a 3D object to be manufactured.

For example, the respective swarm robots of the first set of swarm robots and the second set of swarm robots can collaborate with each other and modulate light beams emitted by the first set of swarm robots to manufacture 3D object 200, wherein 3D object 200 can be truss 202. Modulation of the light beams can comprise reflection, deflection, absorption, splitting, merging and/or other manipulation of the light beams. The respective swarm robots can analyze truss 202 using a 3D model of truss 202 to determine how truss 202 can be manufactured (e.g., where a light beam can be redirected, where the light beam can be stopped, etc.) and whether truss 202 can be produced in a single step or in multiple steps. The 3D model can be a scaled down model (e.g., versus a life-sized model) of truss 202, and the respective swarm robots can receive the 3D model in a digital format based on which the respective swarm robots can identify positions that the respective swarm robots can occupy inside the photosensitive resin tank to manufacture truss 202. That is, based on the shape and dimensions of truss 202, the respective swarm robots can occupy positions relative to one another inside the photosensitive resin to create a light beam simulated model of truss 202. For example, with reference to FIG. 3, based on a 3D model (digital model) received by the respective swarm robots, the respective swarm robots can identify that a distance between point 110 and point 112 is to be 20 centimeters (cm) to manufacture the angle indicated at 204 of truss 202. Further, based on an amount of swarm robots inside the photosensitive resin tank, a sequence of manufacturing can be identified.

Motion performed by the respective swarm robots for occupying the positions inside the photosensitive resin tank can cause turbulence (e.g., turbulence 103) inside the photosensitive resin, and the respective swarm robots can begin production of the 3D object after validating that the turbulence has stopped. For example, after validating that the turbulence has stopped, the first set of swarm robots can begin emitting light beams and the second set of swarm robots can instantly begin modulation of the light beams to manufacture truss 202. As stated earlier, the respective swarm robots can validate that turbulence has stopped via vibration detection sensors, movement detection sensors, cameras or other such sensors installed internal to or external to the respective swarm robots, wherein the sensors can detect whether the photosensitive resin is in motion or at a standstill. An algorithm that can be used to perform the collaboration between the swarm robots can be a standard code known in the art and can be written in Python, C++, or other programming language. Additional aspects of manufacturing 3D object 200 are disclosed with reference to FIG. 3.

FIG. 3 illustrates a system diagram of an example, non-limiting system 300 that can facilitate light emission and modulation by swarm robots for production of a 3D object from photosensitive resin in accordance with one or more embodiments described herein. System 300 can be analogous to system 100. Repetitive description of like elements and/or processes employed in respective embodiments is omitted for sake of brevity.

With continued reference to FIG. 2, system 300 can be used to manufacture 3D object 200. In an embodiment, the respective swarm robots can identify how direction of a light beam can be changed to build truss 202 using light direction simulation, wherein light direction simulation is a technique known in the art to determine an extent to which light can propagate based on reflection of light. For example, the respective swarm robots can determine whether the positions occupied by the respective swarm robots as indicated in FIG. 3 can be suitable for manufacturing the angle of truss 202 highlighted by the circle at 204. As such, robot 104 can emit a laser beam towards robot 108, as indicted by the line connecting points 110 and 112, and since light beams move in a straight line, the respective swarm robots can determine where the laser beam can be redirected and where the laser beam can be stopped from propagating based on the shape of truss 202.

Accordingly, the respective swarm robots can place a mirror, a deflector (e.g., illustrated in FIG. 3 as a curved object coupled to robot 108) and/or an absorber (e.g., illustrated in FIG. 3 as rectangular surfaces respectively coupled to robot 106_{A} and robot 106_{B}). As such, emission 302 can cause light beams to be emitted by the first set of swarm robots, deflection 306 can cause the light beams to be deflected by a subset of the second set of swarm robots and absorption 304 can cause the light beams to be absorbed by another subset of the second set of swarm robots. Absorption 304 can prevent the light beams to move past the absorbing surfaces coupled to robot 106_{A} and robot 106_{B} and thereby prevent solidification of the photosensitive resin beyond the absorbing surfaces (e.g., versus requiring removal of superfluous portions of solidified photosensitive resin). As stated elsewhere herein, the respective swarm robots can occupy positions suitable for manufacturing truss 202 (e.g., system 100, system 300), and after validating that turbulence caused in the photosensitive resin has stopped, the respective swarm robots can begin manufacturing truss 202 (e.g., system 300).

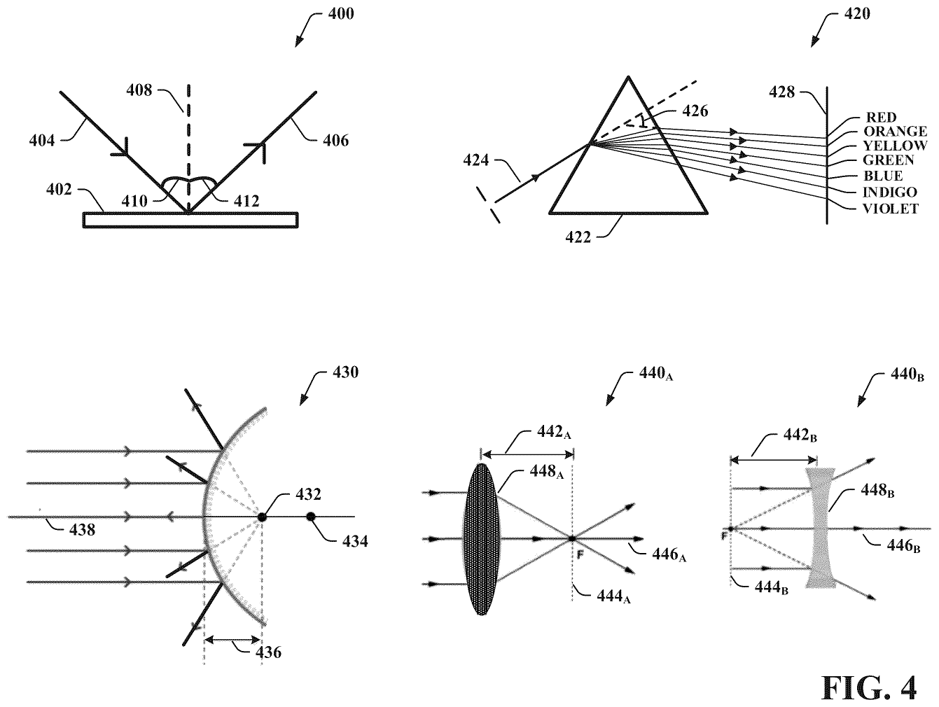

FIG. 4 illustrates ray diagrams of example, non-limiting concepts 400, 420, 430, 440_{A}, 440_{B} that can be implemented by swarm robots for production of a 3D object from photosensitive resin in accordance with one or more embodiments described herein. Repetitive description of like elements and/or processes employed in respective embodiments is omitted for sake of brevity.

As discussed in one or more embodiments herein, a system (e.g., system 100, system 300) comprising a photosensitive resin tank (e.g., photosensitive resin tank 102) and a plurality of swarm robots can manufacture large 3D objects via emission of light beams by a subset of the plurality of swarm robots walking inside the photosensitive resin tank. The photosensitive resin tank can comprise at least two sets of swarm robots (e.g., a first type of swarm robots that can emit light and a second type of swarm robots that can modulate light) that can walk inside the photosensitive resin tank, adjust respective heights, and collaborate with each other to construct the 3D object from photosensitive resin contained in the photosensitive resin tank. For example, while manufacturing the 3D object incrementally, the swarm robots can gradually move upwards and control the light beam to solidify desired portions of the photosensitive resin. Based on the object to be manufactured, the system can evaluate if the object can be manufactured at once or via multiple steps. Further, the system can perform light beam simulation to determine how light can be used to produce a desired shape. The system of the walking robots (i.e., swarm robots) can comprise a variety of light modulation modules such as an absorption module, a deflection module, a reflection module, a splitting module, a merging module, etc. that can respectively simulate absorption, deflection, reflection, splitting, merging, etc. following standard optical calculations as described below. Further, a reflective surface of the reflection module can be made concave or convex for desired redirection of light. The system can simulate how light modulation robots (i.e., the subset of the swarm robots that can modulate light) can be placed inside the photosensitive resin tank to create a desired shape of a projected light beam. Light emitted by a subset of the swarm robots can be immediately modulated by the light modulation robots and the photosensitive resin can instantly begin to solidify.

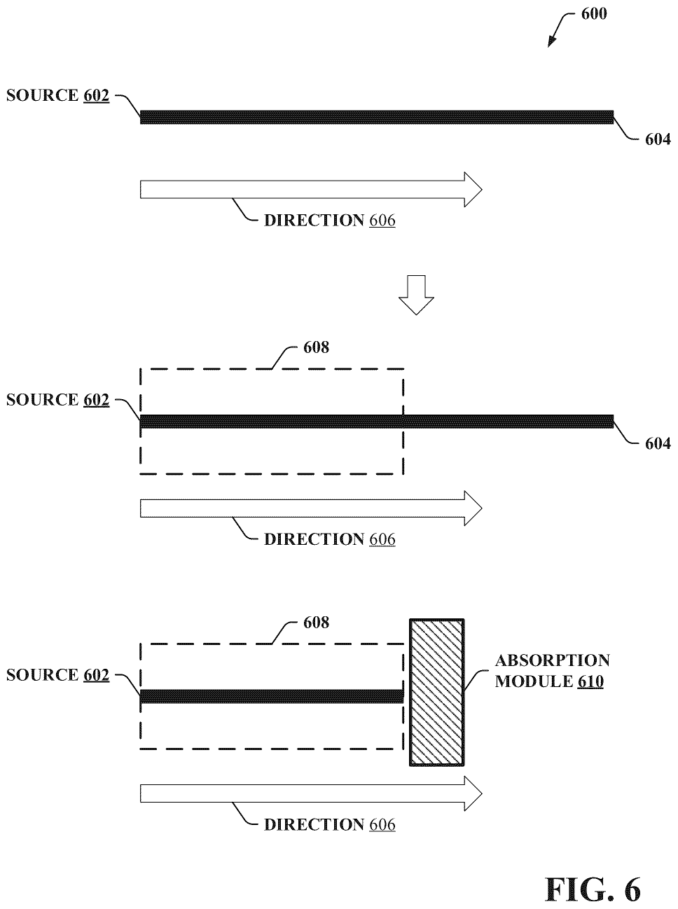

In an embodiment, the respective swarm robots can simulate direction of the light beams and calculate how light needs to move inside the photosensitive resin tank to manufacture a 3D object from photosensitive resin. As stated elsewhere herein, the respective swarm robots can comprise reflectors, deflectors, lenses, light absorbing systems, etc., wherein a light absorbing system can prevent light from propagating past a certain point (e.g., as discussed with reference to FIG. 6) to prevent solidification of photosensitive resin past the point. For example, as illustrated at 400, a swarm robot (e.g., robot 108) can comprise a reflector, such as mirror 402, such that an incident ray of light 404 (e.g., from robot 104) at an angle of incidence 410 (e.g., θ₁) to the normal 408 can be reflected at a suitable angle of reflection 412 (e.g., θ₂) as reflected ray 406. Likewise, as illustrated at 420, a swarm robot can cause deviation (e.g., via prism 422) of an incident ray of light 424 at a deviation angle 426 to change an angle of attack of the incident ray of light 424 and cause splitting of light to generate the spectrum indicated on screen 428 when multiple objects are to be created. In another example, as illustrated at 430, a swarm robot can comprise a spherical mirror (e.g., a concave mirror) with a focal length 436, focal point 432 and center of curvature 434, such that a ray of light incident along principal axis 438 or parallel to principal axis 438 can be reflected by adjusting a position of the spherical mirror, based on a desired angular position of the 3D object to be printed/manufactured. As stated earlier, swarm robots can also comprise lenses. For example, as illustrated at 440_{A}, a swarm robot can comprise bi-convex lens 448_{A} with focal length 442_{A} at focal plane 444_{A}, such that an LED light projected along axis 446_{A} can converge at focal point F to create a certain angular shape for a 3D object. Likewise, as illustrated at 440_{B}, a swarm robot can comprise bi-concave lens 448_{B} with focal length 442_{B} at focal plane 444_{B}, such that an LED light projected along axis 446_{B} can diverge from focal point F.

The system can analyze the 3D object to be manufactured and incrementally decide how a light beam can be applied. The system can identify placement of the robots inside the photosensitive resin tank for manufacturing the 3D object. For example, the system can identify where the swarm robots are placed and accordingly, light beams can be emitted, controlled, redirected, etc. Further, the system can identify a level of transparency of the photosensitive resin and identify a distance up to which a light beam can travel. The system can further analyze viscosity of the photosensitive resin and use the viscosity for calculating an amount of force needed to make a swarm robot float (i.e., remain) in one position. The viscosity can be determined based on a specification of the photosensitive resin. As stated elsewhere herein, the light beam can be reflected, deflected and/or absorbed to change a structure of the 3D object as desired during the manufacturing process. The second type of swarm robots can also alter a reflective/deflective surface to dynamically change a direction of reflected or deflected light. Based on a shape of the light beam, the system can further identify whether the structure of the 3D object is changing. If the system can detect that the structure of the 3D object is ending on a particular position, excess movement of the light beam in a direction can be obstructed and absorbed. For example, the first and second types of swarm robots can occupy appropriate positions on the photosensitive resin and alter movement of the path of light using the various concepts discussed herein. Based on the absorption of light after a desired position, or redirection of light, the photosensitive resin can get immediately solidified at desired locations.

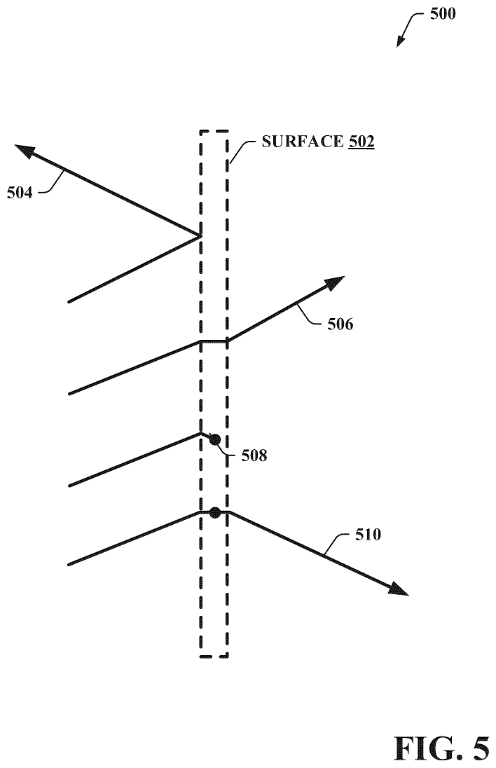

FIG. 5 illustrates a diagram of example, non-limiting functionalities 500 that can be provided by a surface associated with a swarm robot for production of a 3D object from photosensitive resin in accordance with one or more embodiments described herein. Repetitive description of like elements and/or processes employed in respective embodiments is omitted for sake of brevity.

In an embodiment, a system (e.g., system 100, system 300, a robotic system) can comprise a photosensitive resin tank (e.g., photosensitive resin tank 102) comprising photosensitive resin and a plurality of swarm robots (e.g., robot 104 robot 106_{A}, robot 106_{B}, robot 108) immersed in the photosensitive resin. Respective swarm robots of the plurality of swarm robots can occupy positions relative to one another inside the photosensitive resin tank to modulate respective direction of light beams emitted by a subset of the plurality of swarm robots. Modulation of the respective direction of light beams by the respective swarm robots can cause the photosensitive resin contained inside the photosensitive resin tank to solidify in a shape of a 3D object to be manufactured. The system can identify the positions to be occupied by the respective swarm robots inside the photosensitive resin tank based on analysis of a shape and dimensions of the 3D object. The system can also perform light beam analysis (e.g., to determine where to stop the light beam from moving, where to absorb the light beam, where to scatter the light beam, etc.) based on which, the light beams can be redirected to align the light beams according to the shape of the 3D object.

As stated elsewhere herein, the respective swarm robots can be walking robots that can walk inside photosensitive resin tank, and different swarm robots can perform respective individual functions. As such, the respective swarm robots can comprise respective modules for performing the respective individual functions for producing the 3D object, and the system can arrange the respective modules at angular positions suitable for producing the 3D object. For example, since a light beam can move in a straight line, changing an angle of a reflection module, deflection module, and/or absorption module can cause light to be redirected in a straight line, end propagation of light at a target location, etc. As such, the respective swarm robots can appropriately reposition themselves for manufacturing the 3D object. For example, after projection of the light beams on the photosensitive resin, the walking robots can adjust positions such that the light beams can be further adjusted (e.g., to cause a light beam to cover a shorter distance, to change reflection and/or absorption of the light beam, etc.) to manufacture the 3D object as desired.

Further, different surface profiles of the walking robots can redirect light in different ways. For example, the system of the photosensitive resin tank and the plurality of swarm robots can comprise respective surfaces that can deflect, reflect, transmit, absorb and/or scatter incoming light. For example, a swarm robot of the plurality of swarm robots can comprise surface 502, wherein surface 502 can perform reflection of light (as illustrated at 504), transmission of light (as illustrated at 506), absorption of light (as illustrated at 508) or scattering of light (as illustrated at 510). The reflective, absorptive and/or deflective surface profiles can be changed programmatically.

FIG. 6 illustrates a diagram of an example, non-limiting absorption functionality 600 that can be provided by a swarm robot for production of a 3D object from photosensitive resin in accordance with one or more embodiments described herein. Repetitive description of like elements and/or processes employed in respective embodiments is omitted for sake of brevity.

In an embodiment, a system (e.g., system 100, system 300, a robotic system) can comprise a photosensitive resin tank (e.g., photosensitive resin tank 102) comprising photosensitive resin and a plurality of swarm robots (e.g., robot 104 robot 106_{A}, robot 106_{B}, robot 108) immersed in the photosensitive resin. Respective swarm robots of the plurality of swarm robots can occupy positions relative to one another inside the photosensitive resin tank to modulate respective direction of light beams emitted by a subset of the plurality of swarm robots. Modulation of the respective direction of light beams by the respective swarm robots can cause the photosensitive resin contained inside the photosensitive resin tank to solidify in a shape of a 3D object to be manufactured.

In an embodiment, ultraviolet (UV) light can be used for solidification of the photosensitive resin. Exposure to UV light can trigger formation of additional chemical bonds that can help solidify the photosensitive resin to achieve higher mechanical strength and stability. In another embodiment, laser light can be used for solidification of the photosensitive resin. Application of the UV light or the laser light can solidify the photosensitive resin instantly without need for any heating when the light is applied. After emission of the light beam (i.e., UV light or laser light), the respective swarm robots (or robotic systems) inside the photosensitive resin tank can modulate the light beam by reflecting, deflecting, absorbing, scattering, or otherwise redirecting the light beam for precise manufacturing of the 3D object.

Solidification of the photosensitive resin can depend on a strength of the UV light or the laser light applied, however, the strength of a light beam can become gradually reduced, causing partial solidification for larger objects. For example, as illustrated in FIG. 6, source 602 can indicate a source of the light beam, the shaded segment propagating from source 602 along direction 606 can indicate the light beam, and point 604 can indicate a distal end of the light beam. At source 602, the light beam can have the strongest beam strength, at point 604, the light beam can have reduced beam strength and the beam strength can gradually reduce along direction 606. In an exemplary scenario, only the portion of the light beam marked by box 608 in the dashed lines can be needed for manufacturing a certain part or part thickness, and the portion of the light beam outside of box 608 can be superfluous and cause deformation of the 3D object via extra solidification.

To facilitate using only the needed portion of the light beam, absorption module 610 (e.g., such as coupled to robot 106_{A} and robot 106_{B} in FIGS. 1 and 3) can be placed in the path of the UV light or the laser light, as illustrated in FIG. 6, to prevent the UV light or the laser light from moving beyond a point (e.g., beyond a desired thickness of the 3D object or a portion of the 3D object) or being reflected, such that the 3D object can be precisely manufactured. A reflection module and/or a deflection module can be similarly adjusted.

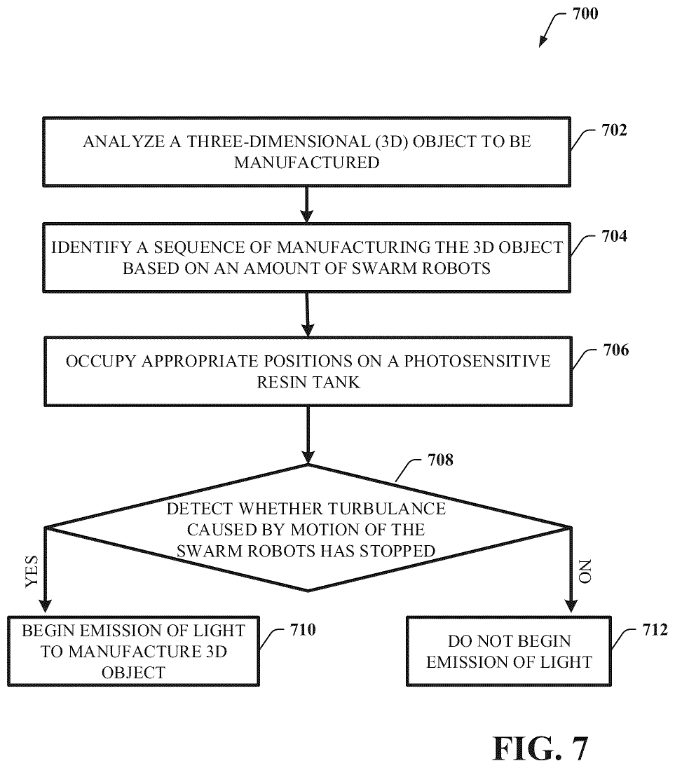

FIG. 7 illustrates a flow diagram of an example, non-limiting method 700 that can facilitate swarm robot collaboration for production of a 3D object from photosensitive resin in accordance with one or more embodiments described herein. Repetitive description of like elements and/or processes employed in respective embodiments is omitted for sake of brevity.

At 702 of the non-limiting method 700, a robotic system (e.g., system 100, system 300) can analyze a 3D object (e.g., 3D object 200) to be manufactured.

At 704 of the non-limiting method 700, the robotic system (e.g., system 100, system 300) can identify a sequence of manufacturing the 3D object (e.g., 3D object 200) based on an amount of swarm robots comprised in the robotic system.

At 706 of the non-limiting method 700, the swarm robots can occupy appropriate positions on a photosensitive resin tank comprised in the robotic system.

At 708 of the non-limiting method 700, the robotic system can detect whether turbulence cause by motion of the swarm robots has stopped.

If yes, then at 710 of the non-limiting method 700, a subset of the swarm robots an begin emission of light to manufacture the 3D object.

If no, then at 712 of the non-limiting method 700, the subset of the swarm robots can pause for the turbulence to stop and the emission of light cannot begin.

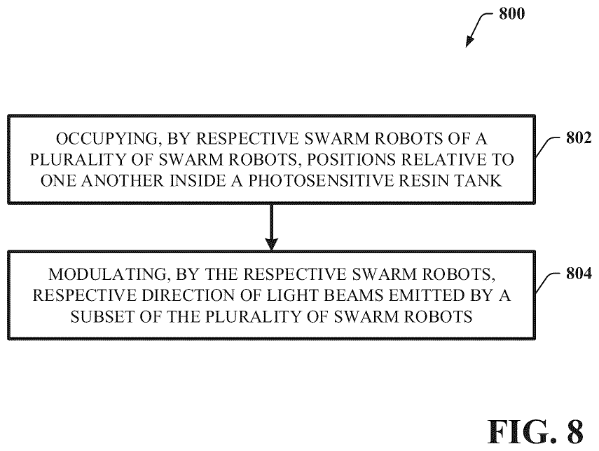

FIG. 8 illustrates another flow diagram of an example, non-limiting method 800 that can facilitate swarm robot collaboration for production of a 3D object from photosensitive resin in accordance with one or more embodiments described herein. Repetitive description of like elements and/or processes employed in respective embodiments is omitted for sake of brevity.

At 802, the non-limiting method 800 can comprise occupying, by respective swarm robots of a plurality of swarm robots (e.g., robot 104, robot 106_{A}, robot 106_{B} and robot 108), positions relative to one another inside a photosensitive resin tank.

At 804, the non-limiting method 800 can comprise modulating, by the respective swarm robots (e.g., robot 104, robot 106_{A}, robot 106_{B} and robot 108), respective direction of light beams emitted by a subset of the plurality of swarm robots.

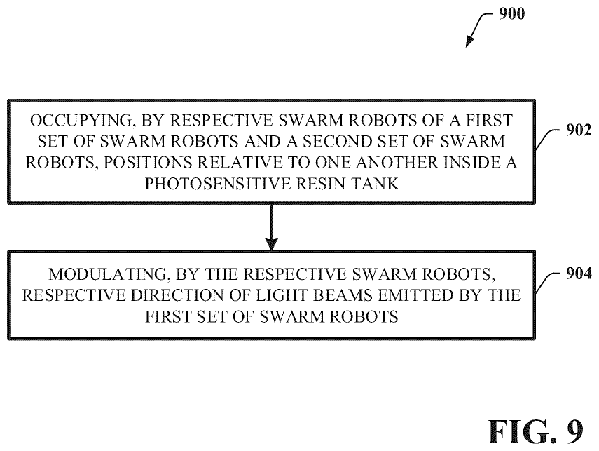

FIG. 9 illustrates yet another flow diagram of an example, non-limiting method 900 that can facilitate swarm robot collaboration for production of a 3D object from photosensitive resin in accordance with one or more embodiments described herein. Repetitive description of like elements and/or processes employed in respective embodiments is omitted for sake of brevity.

At 902, the non-limiting method 900 can comprise occupying, by respective swarm robots of a first set of swarm robots and a second set of swarm robots, positions relative to one another inside a photosensitive resin tank.

At 904, the non-limiting method 900 can comprise modulating, by the respective swarm robots, respective direction of light beams emitted by the first set of swarm robots.

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. Additionally, the computer-implemented methodologies described hereinafter and throughout this specification are capable of being stored on an article of manufacture to enable transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

One or more embodiments described herein can employ hardware and/or software to solve problems that are highly technical, that are not abstract, and that cannot be performed as a set of mental acts by a human. For example, a human, or even thousands of humans, cannot efficiently, accurately and/or effectively modulate light beams inside photosensitive resin by reflecting, deflecting, absorbing, scattering, merging or otherwise redirecting the light beams for precise manufacturing of a 3D object as the one or more embodiments described herein can enable this process. And, neither can the human mind nor a human with pen and paper analyze a digital model of the 3D object to determine whether or how the 3D object can be manufactured via a robotic system, as conducted by one or more embodiments described herein.

FIG. 10 illustrates a block diagram of an example, non-limiting, operating environment in which one or more embodiments described herein can be facilitated. FIG. 10 and the following discussion are intended to provide a general description of a suitable operating environment 1000 in which one or more embodiments described herein at FIGS. 1-9 can be implemented.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1000 contains an example of an environment for the execution of at least some of the computer code involved in performing the inventive methods, such as swarm robot collaboration code 1045. In addition to block 1045, computing environment 1000 includes, for example, computer 1001, wide area network (WAN) 1002, end user device (EUD) 1003, remote server 1004, public cloud 1005, and private cloud 1006. In this embodiment, computer 1001 includes processor set 1010 (including processing circuitry 1020 and cache 1021), communication fabric 1011, volatile memory 1012, persistent storage 1013 (including operating system 1022 and block 1045, as identified above), peripheral device set 1014 (including user interface (UI), device set 1023, storage 1024, and Internet of Things (IoT) sensor set 1025), and network module 1015. Remote server 1004 includes remote database 1030. Public cloud 1005 includes gateway 1040, cloud orchestration module 1041, host physical machine set 1042, virtual machine set 1043, and container set 1044.

COMPUTER 1001 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1030. As is well understood in the art of computer technology, and depending upon the technology, performance of a computer-implemented method may be distributed among multiple computers and/or between multiple locations. On the other hand, in this presentation of computing environment 1000, detailed discussion is focused on a single computer, specifically computer 1001, to keep the presentation as simple as possible. Computer 1001 may be located in a cloud, even though it is not shown in a cloud in FIG. 10. On the other hand, computer 1001 is not required to be in a cloud except to any extent as may be affirmatively indicated.

PROCESSOR SET 1010 includes one, or more, computer processors of any type now known or to be developed in the future. Processing circuitry 1020 may be distributed over multiple packages, for example, multiple, coordinated integrated circuit chips. Processing circuitry 1020 may implement multiple processor threads and/or multiple processor cores. Cache 1021 is memory that is located in the processor chip package(s) and is typically used for data or code that should be available for rapid access by the threads or cores running on processor set 1010. Cache memories are typically organized into multiple levels depending upon relative proximity to the processing circuitry. Alternatively, some, or all, of the cache for the processor set may be located “off chip.” In some computing environments, processor set 1010 may be designed for working with qubits and performing quantum computing.

Computer readable program instructions are typically loaded onto computer 1001 to cause a series of operational steps to be performed by processor set 1010 of computer 1001 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1021 and the other storage media discussed below. The program instructions, and associated data, are accessed by processor set 1010 to control and direct performance of the inventive methods. In computing environment 1000, at least some of the instructions for performing the inventive methods may be stored in block 1045 in persistent storage 1013.

COMMUNICATION FABRIC 1011 is the signal conduction paths that allow the various components of computer 1001 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1012 is any type of volatile memory now known or to be developed in the future. Examples include dynamic type random access memory (RAM) or static type RAM. Typically, the volatile memory is characterized by random access, but this is not required unless affirmatively indicated. In computer 1001, the volatile memory 1012 is located in a single package and is internal to computer 1001, but, alternatively or additionally, the volatile memory may be distributed over multiple packages and/or located externally with respect to computer 1001.

PERSISTENT STORAGE 1013 is any form of non-volatile storage for computers that is now known or to be developed in the future. The non-volatility of this storage means that the stored data is maintained regardless of whether power is being supplied to computer 1001 and/or directly to persistent storage 1013. Persistent storage 1013 may be a read only memory (ROM), but typically at least a portion of the persistent storage allows writing of data, deletion of data and re-writing of data. Some familiar forms of persistent storage include magnetic disks and solid state storage devices. Operating system 1022 may take several forms, such as various known proprietary operating systems or open source Portable Operating System Interface type operating systems that employ a kernel. The code included in block 1045 typically includes at least some of the computer code involved in performing the inventive methods.

PERIPHERAL DEVICE SET 1014 includes the set of peripheral devices of computer 1001. Data communication connections between the peripheral devices and the other components of computer 1001 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1023 may include components such as a display screen, speaker, microphone, wearable devices (such as goggles and smart watches), keyboard, mouse, printer, touchpad, game controllers, and haptic devices. Storage 1024 is external storage, such as an external hard drive, or insertable storage, such as an SD card. Storage 1024 may be persistent and/or volatile. In some embodiments, storage 1024 may take the form of a quantum computing storage device for storing data in the form of qubits. In embodiments where computer 1001 is required to have a large amount of storage (for example, where computer 1001 locally stores and manages a large database) then this storage may be provided by peripheral storage devices designed for storing very large amounts of data, such as a storage area network (SAN) that is shared by multiple, geographically distributed computers. IoT sensor set 1025 is made up of sensors that can be used in Internet of Things applications. For example, one sensor may be a thermometer and another sensor may be a motion detector.

NETWORK MODULE 1015 is the collection of computer software, hardware, and firmware that allows computer 1001 to communicate with other computers through WAN 1002. Network module 1015 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1015 are performed on the same physical hardware device. In other embodiments (for example, embodiments that utilize software-defined networking (SDN)), the control functions and the forwarding functions of network module 1015 are performed on physically separate devices, such that the control functions manage several different network hardware devices. Computer readable program instructions for performing the inventive methods can typically be downloaded to computer 1001 from an external computer or external storage device through a network adapter card or network interface included in network module 1015.

WAN 1002 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1003 is any computer system that is used and controlled by an end user (for example, a customer of an enterprise that operates computer 1001), and may take any of the forms discussed above in connection with computer 1001. EUD 1003 typically receives helpful and useful data from the operations of computer 1001. For example, in a hypothetical case where computer 1001 is designed to provide a recommendation to an end user, this recommendation would typically be communicated from network module 1015 of computer 1001 through WAN 1002 to EUD 1003. In this way, EUD 1003 can display, or otherwise present, the recommendation to an end user. In some embodiments, EUD 1003 may be a client device, such as thin client, heavy client, mainframe computer, desktop computer and so on.

REMOTE SERVER 1004 is any computer system that serves at least some data and/or functionality to computer 1001. Remote server 1004 may be controlled and used by the same entity that operates computer 1001. Remote server 1004 represents the machine(s) that collect and store helpful and useful data for use by other computers, such as computer 1001. For example, in a hypothetical case where computer 1001 is designed and programmed to provide a recommendation based on historical data, then this historical data may be provided to computer 1001 from remote database 1030 of remote server 1004.

PUBLIC CLOUD 1005 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 1005 is performed by the computer hardware and/or software of cloud orchestration module 1041. The computing resources provided by public cloud 1005 are typically implemented by virtual computing environments that run on various computers making up the computers of host physical machine set 1042, which is the universe of physical computers in and/or available to public cloud 1005. The virtual computing environments (VCEs) typically take the form of virtual machines from virtual machine set 1043 and/or containers from container set 1044. It is understood that these VCEs may be stored as images and may be transferred among and between the various physical machine hosts, either as images or after instantiation of the VCE. Cloud orchestration module 1041 manages the transfer and storage of images, deploys new instantiations of VCEs and manages active instantiations of VCE deployments. Gateway 1040 is the collection of computer software, hardware, and firmware that allows public cloud 1005 to communicate through WAN 1002.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1006 is similar to public cloud 1005, except that the computing resources are only available for use by a single enterprise. While private cloud 1006 is depicted as being in communication with WAN 1002, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1005 and private cloud 1006 are both part of a larger hybrid cloud.

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed:

1. A system, comprising:
a photosensitive resin tank; and
a plurality of swarm robots moving inside the photosensitive resin tank, wherein respective swarm robots occupy positions relative to one another to modulate respective direction of light beams emitted by a subset of the plurality of swarm robots.

2. The system of claim 1, wherein modulation of the respective direction of light beams by the respective swarm robots causes photosensitive resin contained inside the photosensitive resin tank to solidify in a shape of a three-dimensional (3D) object.

3. The system of claim 2, wherein the respective swarm robots analyze the 3D object to determine whether the 3D object is to be produced in a single step or in multiple steps.

4. The system of claim 3, wherein at least two split portions of the 3D object are manufactured for constructing the 3D object in multiple steps, and wherein the at least two split portions are merged or assembled after manufacturing.

5. The system of claim 2, wherein based on the shape and dimensions of the 3D object, the respective swarm robots occupy positions relative to one another inside the photosensitive resin to create a light beam simulated model of the 3D object.

6. The system of claim 2, wherein the respective swarm robots comprise respective modules for performing respective individual functions for producing the 3D object, and wherein the system arranges the respective modules at angular positions suitable for producing the 3D object.

7. The system of claim 6, wherein the respective individual functions are selected from a group comprising at least one of emitting a light beam, reflecting the light beam, deflecting the light beam, absorbing the light beam, and converging, diverting or splitting the light beam.

8. The system of claim 1, wherein motion performed by the respective swarm robots for occupying the positions relative to one another causes turbulence inside the photosensitive resin tank, and wherein the respective swarm robots begin emission of the light beams after validating that the turbulence has stopped.

9. A computer program product for collaboration of swarm robots for light beam modulation, the computer program product comprising a computer readable storage medium having program instructions embodied therewith, the program instructions executable by a processor of a swarm robot to cause the processor to:
communicate with respective swarm robots of a first set of swarm robots and a second set of swarm robots to cause the respective swarm robots to occupy positions relative to one another inside a photosensitive resin tank to modulate respective direction of light beams emitted by the first set of swarm robots.

10. The computer program product of claim 9, wherein modulation of the respective direction of light beams by the respective swarm robots causes photosensitive resin contained inside the photosensitive resin tank to solidify in a shape of a 3D object.

11. The computer program product of claim 10, wherein the respective swarm robots analyze the 3D object to determine whether the 3D object is to be produced in a single step or in multiple steps.

12. The computer program product of claim 11, wherein at least two split portions of the 3D object are manufactured for constructing the 3D object in multiple steps, and wherein the at least two split portions are merged or assembled after manufacturing.

13. The computer program product of claim 9, wherein the program instructions are further executable by the processor to cause the processor to:
communicate with the respective swarm robots to cause the swarm robots to occupy the positions relative to one another inside the photosensitive resin tank to create a light beam simulated model of a 3D object, based on a shape and dimensions of the 3D object.

14. The computer program product of claim 9, wherein the first set of swarm robots comprises a light beam emission module for emitting the light beams.

15. The computer program product of claim 9, wherein the second set of swarm robots comprises a module for reflecting the light beams, deflecting the light beams, or absorbing the light beams to modulate the respective direction of the light beams.

16. The computer program product of claim 9, wherein motion performed by the respective swarm robots for occupying the positions relative to one another causes turbulence inside the photosensitive resin tank, and wherein the respective swarm robots begin emission of the light beams after validating that the turbulence has stopped.

17. A method comprising:
occupying, by respective swarm robots of a plurality of swarm robots, positions relative to one another inside a photosensitive resin tank; and
modulating, by the respective swarm robots, respective direction of light beams emitted by a subset of the plurality of swarm robots.

18. The method of claim 17, wherein modulation of the respective direction of light beams by the respective swarm robots causes photosensitive resin contained inside the photosensitive resin tank to solidify in a shape of a 3D object.

19. The method of claim 18, further comprising:
analyzing, by the respective swarm robots, the 3D object to determine whether the 3D object is to be produced in a single step or in multiple steps.

20. The method of claim 19, wherein at least two split portions of the 3D object are manufactured for constructing the 3D object in multiple steps, and wherein the at least two split portions are merged or assembled after manufacturing.
